(19) United States
(12) Patent Application Publication
(10) Pub. No.: US 2006/0069963 A1
(43) Pub. Date: Mar. 30, 2006

(54) Device and method for controlling a console

(75) Inventor: Denis Miglianico, Tassin-La-Demi-Lune (FR)

Correspondence Address: DAVIDSON, DAVIDSON & KAPPEL, LLC, 485 SEVENTH AVENUE, 14TH FLOOR, NEW YORK, NY, 10018, US

(73) Assignee: ALSTOM Transport SA, Levallois-Perret (FR)

(21) Appl. No.: 11/225,978

(22) Filed: Sep. 14, 2005

(30) Foreign Application Priority Data
Sep. 15, 2004 (FR) FR 04 09788

(51) Int. Cl. G06F 11/00

(52) U.S. Cl. 714/46

(57) ABSTRACT

The invention relates to a control device (3) intended to test a console (2) which can process display commands.

The control device (3) comprises, in a container which is separate from the container of the console (2):
memory means (24) which can store test display commands (DT) and an exact test video signal (DTE);
first temporary connection means (32, 33, 34, 35, 36, 37) for temporary connection to the receiving means (16, 17, 18) of the console (2), which first temporary connection means can transmit the test display commands (DT) to the processing means (8, 10) of the console (2);
second temporary connection means (42, 44) for temporary connection to the transmission means (20) of the console (2), which second temporary connection means can receive the test video signal produced by the processing means (8, 10) of the console (2); and
comparison means (40) which can compare the test video signal produced with the exact test video signal (DTE) and which can generate a result which represents the correct function or malfunction of the processing means (8, 10) of the console (2). The invention also relates to a method for controlling a console.

### BACKGROUND OF THE INVENTION

The invention relates to a device for controlling a console which can process display commands and a method for controlling such a console.

The invention relates in particular to a control device which is intended to test a console which can process display commands, the console comprising means for receiving display commands, means for processing the display commands received and transmission means which are intended to transmit the video signal produced by the processing means to a display device.

The invention is applied to the field of consoles which are intended for railway traction vehicles. Those vehicles comprise a console which is used to control the advance thereof, the equipment integrated in the vehicle and optionally the trackside equipment of the railway network.

That console is connected to a character acquisition device (keyboard, . . . ) and a pointing device (mouse, touch screen, . . . ) in order to direct the instructions of the driver to an on-board data-processing network and a screen for displaying those instructions and information in order to receive information relating to the vehicle and the equipment thereof. The screen is controlled by the console on the basis of display commands.

Before it is fitted to a vehicle, it is necessary to ensure the absence of any display error on that screen. Such display errors may be caused by a malfunction of the display screen or by monopolisation of the central processing unit of the console by the looping of a programme, or by faults in the memories which are used to store the data to be displayed, or by any other hardware or software incident which has an impact on the operation of the console.

The correct operation of the display screen is generally verified directly by the manufacturer thereof.

It is known for any malfunction of the processing carried out by the console usually to be tested by an operator who inputs display commands into the console by means of the character acquisition device and the pointing device and who visually verifies whether the display on the screen corresponds to the expected icons and text.

However, those tests are long and require the sustained attention of the operator. Furthermore, those tests comprise compulsory periods of waiting in order to allow any errors to be detected.

Furthermore, there are known programmes for controlling the processing of the console, which programmes are intended to be recorded on storage means of the console and which can be executed directly by means of the central processing unit of the console itself (also referred to as a self-test programme).

However, those programmes use processing, calculating and storage means of the console undergoing the test so that the results of those tests are not reliable if the console itself is not functioning normally.

The object of the invention is to provide a more reliable control device.

### SUMMARY OF THE INVENTION

To that end, the invention relates to a control device of the above-mentioned type, wherein it comprises, in a container which is separate from the container of the console:
memory means which can store test display commands and an exact test video signal;
first temporary connection means for temporary connection to the receiving means of the console, which first temporary connection means can transmit the test display commands to the processing means of the console;
second temporary connection means for temporary connection to the transmission means of the console, which second temporary connection means can receive the test video signal produced by the processing means of the console; and
comparison means which can compare the test video signal produced with the exact test video signal and which can generate a result which represents the correct function or malfunction of the processing means of the console.

According to particular embodiments, the device comprises one or more of the following features:
the first connection means can be connected to at least a port for access to an on-board data-processing network of the console in order to supply test display commands of the image type and character type to the processing means of the console;
the first connection means can be connected to at least a keyboard input port of the console in order to supply test display commands of the character type to the processing means of the console;
the first connection means can be connected to at least a mouse input port of the console in order to supply test display commands of the type involving positioning a cursor and/or validating an image or a character with respect to the processing means of the console;
the second connection means are suitable for connection to at least a video output port of the console in order to receive the test video signal produced by the processing means of the console;
it further comprises a human/machine interface for presenting the result generated by the comparison means;
it further comprises a converter which can convert the test display commands from a first format which is specific to the control device into a second format which can be interpreted by the receiving means of the console;
it further comprises a converter which can convert the test video signal produced which is received by the second connection means into digital pieces of information; and
electronic components which form the memory means and the comparison means of the control device are discrete and separate from the electronic components which form the processing means of the console.

The invention also relates to a method for controlling a console for processing display commands by means of a control device, wherein it comprises the following steps:
transmitting, by first connection means of the control device, test display commands to receiving means of the console;
processing the test display commands by processing means of the console;
receiving, by second connection means of the control device, a test video signal produced which is transmitted by transmission means of the console;
comparing the test video signal produced with the exact test video signal by comparison means of the control device; and
presenting a result which represents the correct function or malfunction of the processing means of the console on a human/machine interface of the control device on the basis of the result of the comparison.

### BRIEF DESCRIPTION OF THE DRAWINGS

The invention will be better understood from a reading of the following description which is given purely by way of example and with reference to the appended drawings, in which:

FIG. 1 is a schematic view of a console and a control device according to the invention; and

FIG. 2 is a flow chart illustrating the control method according to the invention.

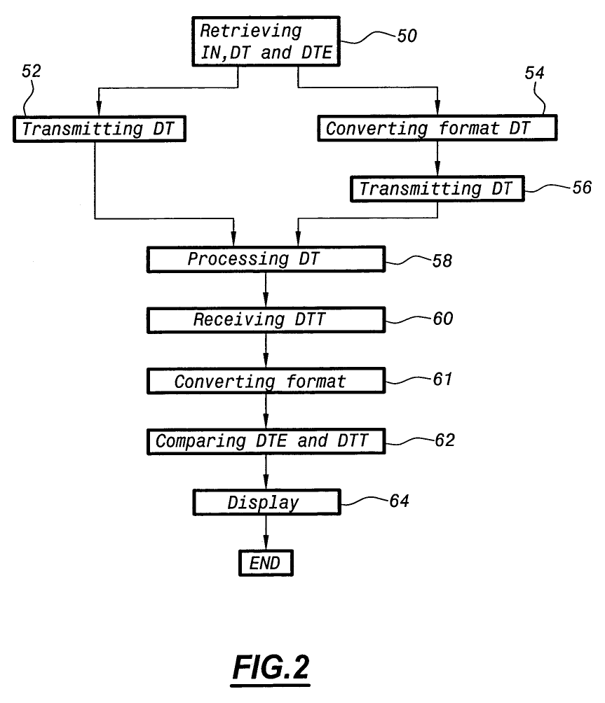

### DETAILED DESCRIPTION OF THE INVENTION

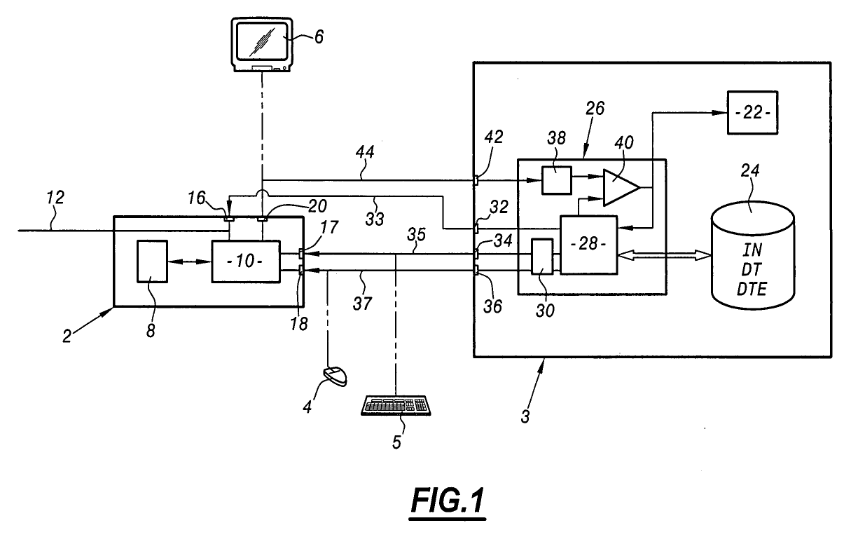

A console 2 and a control device 3 are schematically illustrated in FIG. 1. In the embodiment of the invention described, the console 2 is intended for railway traction vehicles. During normal operation thereof, the console 2 is connected to a mouse 4, a keyboard 5 and a display device 6. During a control operation of the console, it is connected to a control device 3, as illustrated in FIG. 1.

The console 2 is able to process display commands and, to that end, comprises in particular a storage memory 8 which is connected to a central processing unit 10 which is constituted by a microprocessor.

The storage memory 8 is suitable for storing, in a database, images, icons and characters or strings of characters which are pre-recorded and identified by display commands. Those icons and characters illustrate operating states of the traction vehicle and the equipment thereof.

During normal operation thereof, the central processing unit 10 is able to receive display commands by means of an on-board data-processing network 12, the mouse 4 and the keyboard 5, to process them, in particular to retrieve the images, icons and characters or strings of characters, identified by those display commands, in the memory 8, and to supply to the display device 6 processed data which form a video signal, referred to hereinafter as the video signal produced. The central processing unit can also store events and trigger alarms in accordance with the information received via the network or via the keyboard.

The central processing unit 10 is connected to the on-board data-processing network 12 of the vehicle in order also to receive operating parameters of the traction vehicle and the electrical equipment of the vehicle, such as, for example, the speed, acceleration thereof, etc. The network 12 is an ETHERNET, CAN (Controller Array Network), LON (Local Operating Network), MVB (Multifunction Vehicle Bus), FIP (Factory Industrial Protocol) type network. The network 12 comprises an access port 16 which allows display commands to be transmitted to the central processing unit 10.

The central processing unit 10 is also connected to a keyboard input port 17 and a mouse input port 18 which are integrated in the console 2. The keyboard input port 17 and mouse input port 18 are intended to be connected to the keyboard 5 and the mouse 4, respectively, in order to receive, during conventional operation thereof, display commands from the user of the console. Those display commands are of the type involving positioning of the cursor, validating a piece of information or displaying a character or a string of characters.

The central processing unit 10 is also connected to a video output port 20 which is intended to be connected to the display device 6 in order to transmit the video signal produced by the central processing unit 10. The video signal produced is an analogue video signal of the type XGA, VGA, SXGA, SVGA, UXGA or a digital video signal of the type LVDS. (XGA: eXtended Graphics Array; VGA: Video Graphics Array; SVGA: Super Video Graphics Array; SXGA: Super eXtended Graphics Array; UXGA: Ultra Extended Graphics Array).

The control device 3 according to the invention is able to verify the processing of the display commands which is carried out by the console 2. It is discrete, separate and independent from the console 2. It is connected to the console 2 only during the test method thereof.

It comprises a human/machine interface 22, a database 24 and test means 26.

The human/machine interface 22 is able to present the results of the tests carried out by the test means 26. It is, for example, constituted by a display screen or a printing device.

The database 24 comprises summary instructions IN of the steps for executing the tests, test display commands DT and an exact test video signal DTE.

The test display commands DT comprise pieces of information of the image type, character type and of the type involving positioning a cursor or validating an image or character displayed. They are able to be sent to the central processing unit 10 of the console in order to test the operation thereof. The test display commands DT are in predetermined formats which can be used directly by the inputs 16, 17, 18 of the console 2, such as, for example, the format RS 232.

The exact test video signal DTE is a correct test video signal, that is to say, a video signal produced by a console 2 which does not have any malfunction or any fault. Each exact test video signal DTE is associated with one, or a series of, test display command(s) DT.

The test means 26 are able to test the processing of the commands DT which is carried out by the central processing unit 10 of the console. They are constituted by a microprocessor and suitable programmes and are connected to the database 24. They comprise a calculation unit 28 and a conversion unit 30.

The calculation unit 28 can retrieve, from the database 24, the instructions IN, the test display commands DT and the exact test video signal DTE corresponding to those test display commands DT. It is suitable for applying the instructions IN and in particular for selecting a port of the console, that is to say, the port 16, 17 or 18, in accordance with the instructions IN.

To that end, the control device 3 comprises three output connectors 32, 34, 36.

In particular, the calculation unit 28 is able to send test display commands DT of the image type or character type, to the central processing unit 10 by means of the connector 32 which is connected, during the test, to the access port 16 of the console by a cable 33.

The calculation unit 28 is also suitable for sending commands DT of the character type to the central processing unit 10 by means of the connector 34 which is connected, during the test, by a cable 35 to the keyboard input port 17 of the console.

Finally, the calculation unit 28 is able to send commands DT of the type involving positioning a cursor and validating an image or a character with respect to the central processing unit 10 by means of the connector 36 which is connected, during the test, by a cable 37 to the mouse input port 18 of the console.

It is able to control series of tests comprising a plurality of successive tests, whose sequence depends on the result of the previous tests in accordance with the instructions IN.

The conversion unit 30 is connected to the calculation unit 28 and the connectors 34 and 36 in order to convert the test display commands DT into a format which can be read by the console 2. That format is dependent on the type of console tested. The unit 30 is able to convert the commands DT, for example, from RS232 format to USB (USB: Universal Serial Bus) or PS/2 (PS2: Personal System/2) format and/or from USB format to PS/2 format.

The test means 26 further comprise a card type converter 38 for acquiring and converting video signals which is connected at its output to comparison means 40.

The card 38 is connected at its input to a connector 42 of the device 3 which is connected, during the test, to the video output port 20 of the console by a cable 44 in order to receive the test video signal DTT produced by the central processing unit 10.

The card 38 can convert the signal DTT produced from a video format into a format which can be read by the comparison means 40.

The comparison means 40 are suitable for comparing the test video signal DTT produced, which is communicated by the comparison means 40, with the exact test video signal DTE which is communicated by the calculation unit 28 and which corresponds to the test display commands DT sent to the central processing unit 10 of the console.

The comparison means 40 can generate, at the output, a result which represents the correct function or malfunction of the processing of the commands DT carried out by the console.

The comparison means 40 can transmit that result to the human/machine interface 22 and to the calculation unit 28.

During operation, during step 50, the calculation unit 28 of the control device retrieves, from the database 24, the instructions IN, the test display commands DT and the exact test video signal DTE.

Subsequently, the unit 28 carries out the steps 52 and 58 to 64 or the steps 54, 56 and 58 to 64 in accordance with the instructions IN of the test to be carried out.

When the unit 28 carries out the step 52, it transmits the test display commands DT, of the image or character type, to the central processing unit 10 of the console by means of the connector 32 which is connected to the access port 16 of the console by means of the cable 33.

When the unit 28 carries out the steps 54 and 56, it sends the commands DT of the character type or type involving positioning a cursor or validating a displayed piece of information, to the conversion unit 30 during the step 54. The conversion unit 30 converts the commands DT, for example, from RS232 format to PS/2 format.

During a step 56, the conversion unit 30 transmits those commands DT to the central processing unit 10 by means of the connector 34 or 36, which is connected to the mouse input port 18 or keyboard input port 17 by the cable 35 or 37, respectively.

During a step 58, the central processing unit 10 of the console receives the commands DT, processes them, and in particular retrieves from the memory 8 the image, character or string of characters corresponding to those commands DT, and transmits the test video signal DTT produced in the video format to the output port 20.

During a step 60, the connector 42 of the control device receives the test video signal DTT produced which is transmitted by the central processing unit 10 to the video output port 20 by means of the cable 44 which is connected to the port 20 and the connector 42.

During a step 61, the acquisition and conversion card 38 processes that signal, converting it into a group of digital pieces of information depending on the definition of the screen. A typical definition is 640 rows by 480 columns in order to make it readable by the comparison means 40.

During a step 62, the calculation unit 28 transmits the exact test video signal DTE retrieved during the step 60 to an input of the comparison means 40. The card 38 transmits the test video signal DTT produced to the other input of the comparison means 40. The comparison means 40 then compare the exact test video signal DTE to the test video signal DTT produced and transmit the result of that comparison to the unit 28 and the human/machine interface 22.

During a step 64, the human/machine interface 22 displays the result of the comparison.

When the exact test video signal DTE does not correspond to the test video signal DTT produced, the result represents that malfunction.

When the commands coincide, the result displayed represents correct processing of the commands DT by the central processing unit 10.

When that operation is carried out, either the test is stopped or the test is continued by repetition of the steps 52, 58 to 64 or by repetition of the steps 54 to 64. For example, a test may comprise an operation during which “an error icon” is displayed, then an operation during which that icon is moved then validated.

Using a control device which is independent of the console to be controlled allows test results which are more reliable to be obtained, that is to say, results which are nearer those obtained during real operation of the console, because there is no interference between the means allowing the tests to be carried out (test means 26) and the means for processing the display commands (processing means 8, 10).

Since the test display commands DT and the exact test video signal DTE are recorded in a database 24, which is independent and separate from the memory 8, the capacity thereof does not need to be increased. Similarly, since the comparison means 40 are not contained in the central processing unit 10, the capacity thereof does not need to be increased.

No test command DT remains recorded in the memory 8 of the console.

The control device according to the invention can take into consideration and test in an interactive manner the console, for example, an icon displayed during a first test may be selected, moved and validated during subsequent tests.

The test video signal DTT produced is received directly at the video output port 20 of the console so that it is not corrupted. In control systems using a video camera which films the display device and shape recognition software which analyses the filmed images, those images are generally distorted, for example, by non-uniform lighting.

1. Control device intended to test a console which can process display commands, the console comprising means for receiving display commands, means for processing the display commands received and transmission means which are intended to transmit to a display device the video signal produced by the processing means, wherein the control device comprises, in a container which is separate from the container of the console:
memory means which can store test display commands and an exact test video signal;
first temporary connection means for temporary connection to the receiving means of the console, which first temporary connection means can transmit the test display commands to the processing means of the console;
second temporary connection means for temporary connection to the transmission means of the console, which second temporary connection means can receive the test video signal produced by the processing means of the console; and
comparison means which can compare the test video signal produced with the exact test video signal and which can generate a result which represents the correct function or malfunction of the processing means of the console.

2. Device according to claim 1, wherein the first connection means can be connected to at least a port for access to an on-board data-processing network of the console in order to supply test display commands of the image type and character type to the processing means of the console.

3. Device according to claim 1, wherein the first connection means can be connected to at least a keyboard input port of the console in order to supply test display commands of the character type to the processing means of the console.

4. Device according to claim 1, wherein the first connection means can be connected to at least a mouse input port of the console in order to supply test display commands of the type involving positioning a cursor and/or validating an image or a character with respect to the processing means of the console.

5. Device according to claim 1, wherein the second connection means are suitable for connection to at least a video output port of the console in order to receive the test video signal produced by the processing means of the console.

6. Device according to claim 1, wherein it further comprises a human/machine interface for presenting the result generated by the comparison means.

7. Device according to claim 1, wherein it further comprises a converter which can convert the test display commands from a first format which is specific to the control device into a second format which can be interpreted by the receiving means of the console.

8. Device according to claim 1, wherein it further comprises a converter which can convert the test video signal produced which is received by the second connection means into digital pieces of information.

9. Device according to claim 1, wherein electronic components which form the memory means and the comparison means of the control device are discrete and separate from the electronic components which form the processing means of the console.

10. Method for controlling a console for processing display commands by means of a control device, wherein it comprises the following steps:
transmitting, by first connection means of the control device, test display commands to receiving means of the console;
processing the test display commands by processing means of the console;
receiving, by second connection means of the control device, a test video signal produced which is transmitted by transmission means of the console;
comparing the test video signal produced with the exact test video signal by comparison means of the control device; and
presenting a result which represents the correct function or malfunction of the processing means of the console on a human/machine interface of the control device on the basis of the result of the comparison.
